(19) United States
(12) Patent Application Publication
(10) Pub. No.: US 2002/0177915 A1
(43) Pub. Date: Nov. 28, 2002

(54) Audio amplifier circuit with digital audio interface and codec device using the same

(76) Inventors: Akinobu Kawamura, Kyoto (JP); Takenori Kato, Kyoto (JP)

Correspondence Address: MATTINGLY, STANGER & MALUR, P.C., Suite 370, 1800 Diagonal Road, Alexandria, VA, 22314, US

(21) Appl. No.: 10/147,863

(22) Filed: May 20, 2002

(30) Foreign Application Priority Data
May 23, 2001 (JP) 2001-153543
May 23, 2001 (JP) 2001-153630

(51) Int. Cl. G06F 17/00; G10L 11/00

(52) U.S. Cl. 700/94; 704/270

(57) ABSTRACT

In a one chipped digital signal processing and amplifying block, in addition to a conversion operation of music related signals, by supplying clocks to an A/D conversion circuit and a D/A conversion circuit through operation of a control circuit, a conversion operation for speech related signals having a lower frequency than a predetermined frequency for the music related signal is caused and data exchange with an external circuit or an external device is performed via a digital interface, thereby, both music related and speech related signals are processed by the one chipped digital signal processing and amplifying block.

### BACKGROUND OF THE INVENTION

1. Field of the Invention

The present invention relates to an audio amplifier circuit with a digital audio interface and a codec device using the same, and more specifically relates to an improvement of an audio amplifier circuit with a digital audio interface dealing speech related voice sound signals and music related audio signals for such as a TV phone and a potable phone performing telecommunication by making use of image and voice sound, which amplifier circuit can be easily formed into one chip IC and can reduce its power consumption.

2. Conventional Art

Such as a codec device for voice sound and audio in a TV phone, a potable phone and other wireless telecommunication units deals two series of digital signals and includes two series of digital audio interfaces. A conventional audio amplifier circuit including such interfaces, for example, employs a structure as shown in FIG. 3.

In FIG. 3, numeral 10 is an audio amplifier circuit with a digital audio interface, 11 is a speech related digital signal processing and amplifying block of 8 kHz sampling frequency series, a portion of which surrounded by a frame is formed into one chip IC, and 12 is an audio related digital signal processing block of 44.1 kHz sampling frequency series, a portion of which surrounded by another frame is formed into one chip IC.

The speech related digital signal processing and amplifying block 11 is constituted by a digital voice interface 111, an 8 bit analog/digital converter (8 bit A/D) 112, an amplifier 113, an 8 bit digital/analog converter (8 bit D/A) 114, an amplifier 115 and a CPU interface 116.

In the digital signal processing and amplifying block 11, an input voice sound signal from an externally connected microphone (hereinbelow will be referred to as mike) 21 is amplified by the amplifier 113, converted into a digital signal by the 8 bit A/D 112 and transferred to the digital voice interface 111 in a form of a digital value of the input voice sound signal. Further, a voice sound output signal transmitted from a party is inputted from the digital voice interface 111 to the 8 bit D/A 114 wherein a digital value is converted into an analog value and the same is sent to the amplifier 115. The voice sound signals amplified by the amplifier 115 are outputted to an externally connected speaker 22. Further, with regard to such as a portable phone, in case of amplification of a melody at the moment of signal reception melody reproducing use digital signals are inputted from the digital voice interface 111 to the 8 bit D/A 114, likely amplified by the amplifier 115 and outputted to the speaker 22.

Herein, both 8 bit A/D 112 and 8 bit D/A 114 respectively perform a conversion operation in response to clocks CK of 8 kHz outputted from the CPU interface 116. Still further, the generation of the clock signals CK of 8 kHz and control of amplification rate of the amplifiers 113 and 115 are performed via the CPU interface 116 by a CPU 25 located at the outside of the one chip IC.

The digital voice interface 111 is connected to a voice sound telecommunication system 26 provided at the outside of the one chip IC.

The audio related digital signal processing and amplifying block 12 is constituted by a digital audio interface 121, a 16 bit analog/digital converter (16 bit A/D) 122, an amplifier 123, a digital attenuator 124, 16 bit digital/analog converters (16 bit D/A) 125R, 125L, low pass filters (LPF) 126R, 126L and amplifiers 127R, 127L. Wherein suffix R represents a right channel in a stereo system and suffix L represents a left channel thereof.

An input from an externally connected mike 23 is amplified by the amplifier 123, converted into a digital signal by the 16 bit A/D 122 and is transferred to the digital audio interface 121 in a form of digital value of the inputted voice sound signal. Further, transmitted music signals are separated by the digital audio interface 121 into the right and left channels in the stereo system and inputted via the digital attenuator 124 respectively into the 16 bit D/As 125R, 125L. The digital values of the transmitted music signals are herein converted into analog values, are respectively inputted into the LPFs 126R, 126L and then outputted through the amplifiers 127R, 127L to an externally connected head phone 24.

The 16 bit A/D 122 and the 16 bit D/As 125R, 125L respectively perform a conversion operation in response to clocks CLK of 44.1 kHz outputted from a clock generating circuit 14. Further, such as amplification rate of the amplifiers 123, 127R and 127L is controlled by a controller 13. The clock generating circuit 14 usually makes use of a crystal oscillator of which crystal is connected at the outside of the one chip IC.

The digital audio interface 121 is connected a music recording and reproducing system 27 for digital processing provided at the outside of the one chip IC.

Further, with regard to recording channel of music signals (voice sound signals) from the mike 23 being transmitted after amplification in FIG. 3 circuit, although only one channel therefor is illustrated, however, through provision of two channels of R and L for the 16 bit A/D 122 and the amplifier 123 so as to correspond to the right and left channels in the stereo system, the respective outputs thereof can be inputted into the digital audio interface 121.

In thus constituted audio amplifier circuit, with the digital audio interface which processes digital signals of the speech related voice sound signals and the music related audio signals, since the sampling clock frequencies for the speech related and the audio related are different, the speech related digital signal processing and amplifying block and the audio related digital signal processing and amplifying block are respectively provided in separate chips. For this reason, further size and weight reduction of the device was difficult and reduction of power consumption thereby was prevented.

### SUMMARY OF THE INVENTION

An object of the present invention is to resolve the above conventional problems and to provide an audio amplifier circuit with a digital audio interface which is easily formed into one chip IC and reduces power consumption thereby.

Another object of the present invention is to provide a codec device with a digital audio interface which is easily formed into one chip IC and reduces power consumption thereby.

An audio amplifier circuit with a digital audio interface and a codec device using the same according to the present invention which achieve the above objects is characterized, in that the audio amplifier circuit with a digital audio interface which processes data having digital values of music related audio signals in a bit number with a higher frequency resolution with respect to digital values of speech related voice sound signals, comprises an A/D conversion circuit which converts analog input signals into digital signals in a predetermined bit number with a predetermined conversion frequency corresponding to the music related audio signals; a D/A conversion circuit which converts the digital signals of the audio signals into analog signals with the predetermined frequency; an amplifier circuit which receives the analog signals from the D/A conversion circuit and amplifies the same; a digital interface which receives the digital signals converted by the A/D conversion circuit, outputs the same to a first external circuit or a first external device and sends out digital signals inputted from the first external circuit or the first external device to the D/A conversion circuit; and a control circuit which supplies clocks or performs a supply control of clocks, wherein the clock has a speech related frequency lower than the predetermined frequency to the A/D conversion circuit and the D/A conversion circuit and whrein a data exchange with the first external circuit or the first external device is performed via the digital interface by causing the A/D conversion circuit and the D/A conversion circuit to perform conversion operation of the music related audio signals as well as another data exchange with a second external circuit or a second external device is performed via the digital interface by supplying the clocks to the A/D conversion circuit and the D/A conversion circuit through operation of the control circuit and by causing the same to perform conversion operation of the speech related voice sound signals.

According to the present invention as has been explained above, in addition to the music related signal conversion operation, since the speech related low frequency clocks are supplied through operation of the control circuit to the A/D conversion circuit and the D/A conversion circuit of the bit number having a high frequency resolution for the music related audio signals to perform the conversion operation of the speech related voice sound signals, the conventional conversion circuit for speech related signals can be eliminated. When performing the conversion operation of speech related signals, the data exchange with the second external circuit or the second external device is performed via the digital interface by making use of the A/D conversion circuit and the D/A conversion circuit. Thereby, both amplifier circuits for the music and speech related signals can be formed into one chip IC.

As a result, the present invention can be achieved only by adding a simple circuit such as a digital voice interface for speech related signals to a conventional digital signal processing and amplifying block for music related signals, or alternatively the present invention can be achieved by separating the digital output side of the audio interface to use as the digital voice interface, thereby, an audio amplifier circuit with a digital audio interface which can be easily formed into one chip IC can be realized.

Further, since a device mounting such audio amplifier circuit is not required to mount separate chips for processing respectively music related signals and speech related signals, the power consumption thereof can be reduced.

### BRIEF DESCRIPTION OF THE DRAWINGS

FIG. 1 is a block diagram of an audio amplifier circuit with a digital audio interface representing one embodiment in which the present invention is applied;

FIG. 2 is a block diagram of an audio amplifier circuit with a digital audio interface representing another embodiment in which the present invention is applied; and

FIG. 3 is a block diagram of a conventional audio amplifier circuit with a digital audio interface.

### DESCRIPTION OF THE PREFERRED EMBODIMENTS

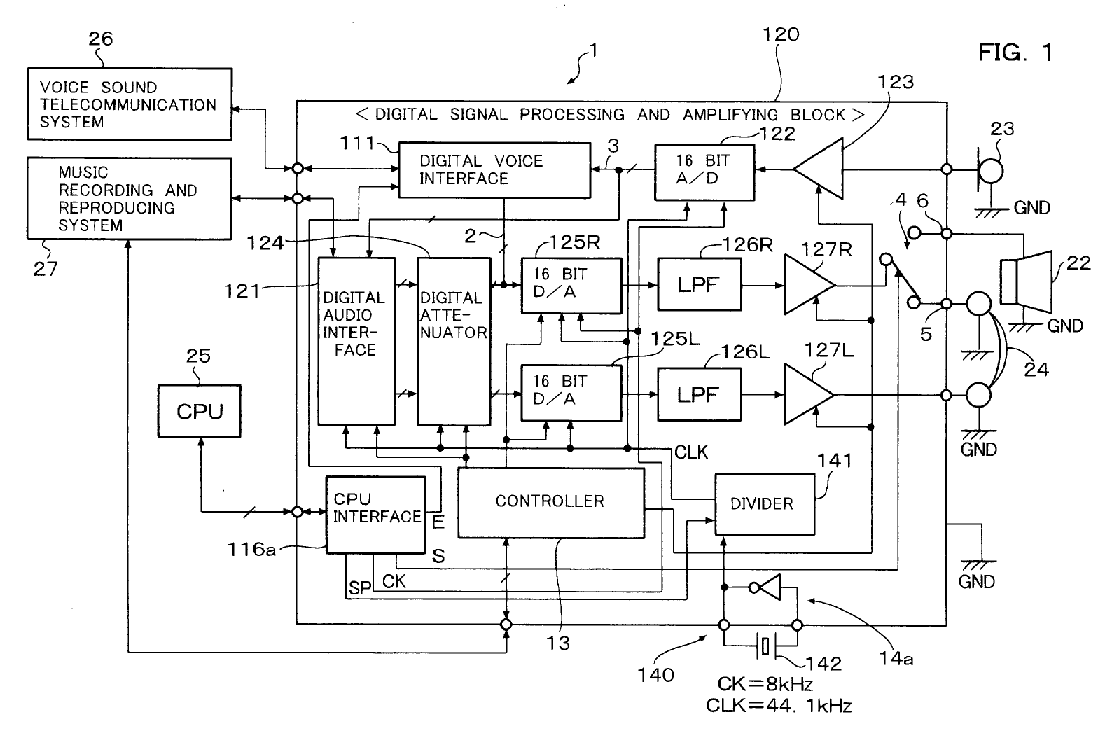

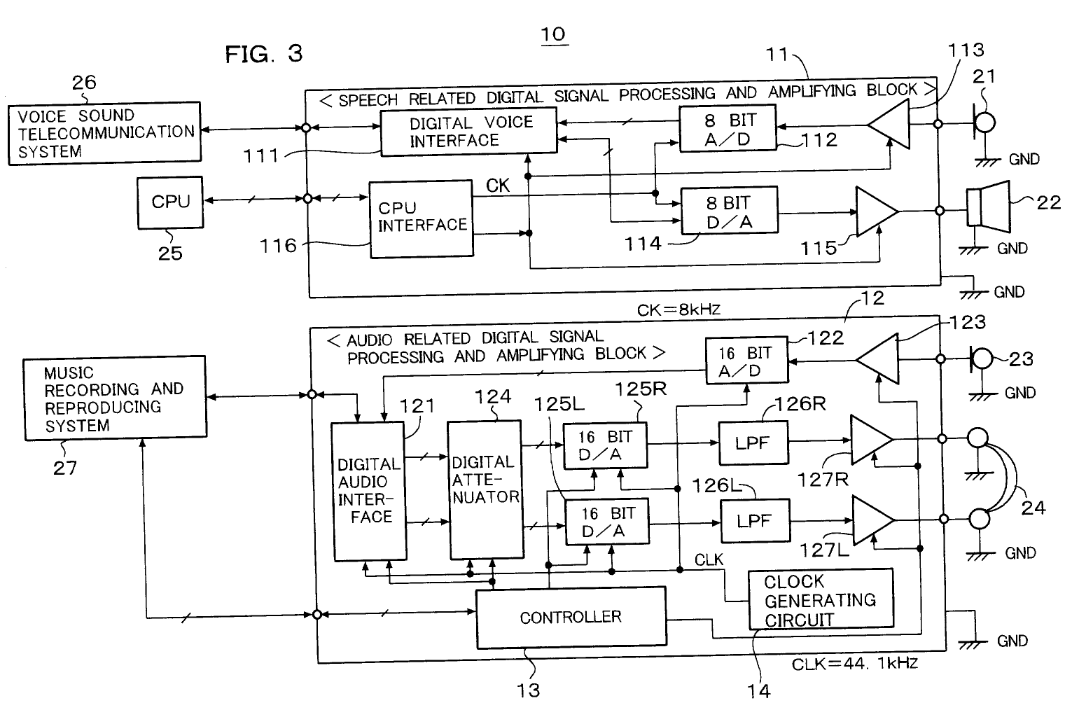

In FIG. 1, numeral 1 is a one chipped audio amplifier circuit with a digital audio interface, and is constituted by a digital signal processing and amplifying block 120 including primarily the audio related digital signal processing and amplifying block 12 as shown in FIG. 3 and a speech related circuit, and a portion surrounded by a frame is formed into one chip IC. In the present embodiment, the 8 bit A/D 112 and the 8 bit D/A 114 as shown in FIG. 3 are not provided. However, an output of the digital voice interface 111 is connected to the 16 bit D/A 125R. This connection is performed through a connection line 2 under OR condition with respect to the output of the digital voice interface 111 separate from the output of a digital audio interface 121, and an 8 bit digits input suitable for the voice sound level is selected among the 16 bit D/A 125R.

Further, 8 bit digits output suitable for voice sound signal level is selected among the 16 bit A/D 122 and the output is connected via a connection line 3 under OR condition to the input of the digital voice interface 111 separate from the input of the digital audio interface 121 as shown in FIG. 3.

Further, in the present embodiment the same constitutional elements as in FIG. 3 are designated by the same reference numerals and the explanation thereof is omitted.

Like in FIG. 3, in FIG. 1 embodiment, with regard to recording of music signals (voice sound signals) which are transmitted from the mike 23 after amplification, although only one channel is illustrated, however, through provision of two channels of R and L for the 16 bit A/D 122 and the amplifier 123 so as to correspond to the right and left channels in the stereo system, the respective outputs thereof can be inputted into the digital voice interface 111.

Further, an output terminal 6 of the speaker 22 and an output terminal 5 of R channel of the head phone 24 are selectively connected to the output of the amplifier 127R via a change-over switch circuit 4. The change-over switch circuit 4 normally connects the output terminal 5 and the output of the amplifier 127R, and the connection of the change-over switch circuit 4 is changed-over toward the output terminal 6 in response to a control signal from the external CPU 25 via a CPU interface 116a.

The CPU interface 116a is a circuit corresponding to the CPU interface 116 as shown in FIG. 3 except that number of control signals being outputted therefrom are increased in comparison with the CPU interface 116, and is connected to the CPU 25 provided outside the chip. Further, the digital voice interface 111 is connected to the voice sound telecommunication system 26 provided outside the chip and the digital audio interface 121 is connected to the music recording and reproducing system 27 likely provided outside the chip.

The 16 bit D/As 125R, 125L and the 16 bit A/D 122 receive clocks CLK of 44.1 kHz from a clock generator circuit 14a as well as receive clocks CK of 8 kHz from the CPU interface 116a.

The clock generator circuit 14a is constituted by a crystal oscillator 140, a divider 141 and a crystal 142, and the crystal 142 is externally connected with respect to the IC chip. The clock generator circuit 14a generates clocks CLK of 44.1 kHz through dividing operation by the divider 141 and sends out the same to the digital audio interface 121, the 16 bit D/As 125R, 125L and the 16 bit A/Ds 122.

When the CPU interface 116a receives an operation control signal (for example, an enable signal) from the CPU 25, the CPU interface 116a generates a control signal SP to interrupt the output of the divider 141, and further changes-over the connection of the change-over switch circuit 4 toward the output terminal 6, then sends out the clocks CK of 8 kHz to the 16 bit D/As 125R, 125L and the 16 bit A/D 122. Still further, the CPU interface 116a generates an enable signal E to place the digital voice interface 111 under operating state.

Now, general operation of the present embodiment will be explained. The audio amplifier circuit 1 is normally constituted like the audio related digital signal processing and amplifying block 12 as shown in FIG. 3, is connected to the music recording and reproducing system 27 and performs recording and reproducing of music signals under the control of the controller 13 via the digital audio interface 121.

When the CPU interface 116a receives a control signal from the external CPU 25, the CPU interface 116a generates a control signal S to change-over the connection of the change-over switch circuit 4 from R channel output terminal 5 toward the output terminal 6, then the clocks CK of 8 kHz are sent out to the 16 bit D/As 125R, 125L and the 16 bit A/D 122. Further, the CPU interface 116a generates an enable signal E to place the digital voice interface 111 under operating state.

With the above, the 16 bit D/As 125R, 125L and the 16 bit A/D 122 receive the clocks CK of 8 kHz from the CPU interface 116a, operate like the speech related digital signal processing and amplifying block 11 in FIG. 3 and perform the data exchange via the digital voice interface 111 with the voice sound telecommunication system 26 for digital processing provided outside the IC chip.

In place of the enable signal generation, in order to further reduce power consumption the operation of the digital audio interface 121 and the digital voice interface 111 can be changed-over through control of power supply change-over in such a manner that the CPU interface 116a generates a control signal for interrupting power supply to the digital audio interface 121 to interrupt the power supply thereto on one hand, and on the other hand to supply electric power to the digital voice interface 111. However, even if the power is supplied to both circuits, the electric power consumed thereby is still suppressed lower than that consumed by the eliminated 8 bit A/D 112 and the 8 bit D/A 114.

As has been explained above, since the present embodiment can be achieved only by adding substantially such as the CPU interface 116a, the digital voice interface 111 and the change-over switch circuit 4 to the conventional digital signal processing and amplifying block 12, the scale of the add circuits can be limited, thereby, the entire circuits can be formed into one chip IC and both speech related and audio related functions can be realized in a single chip IC.

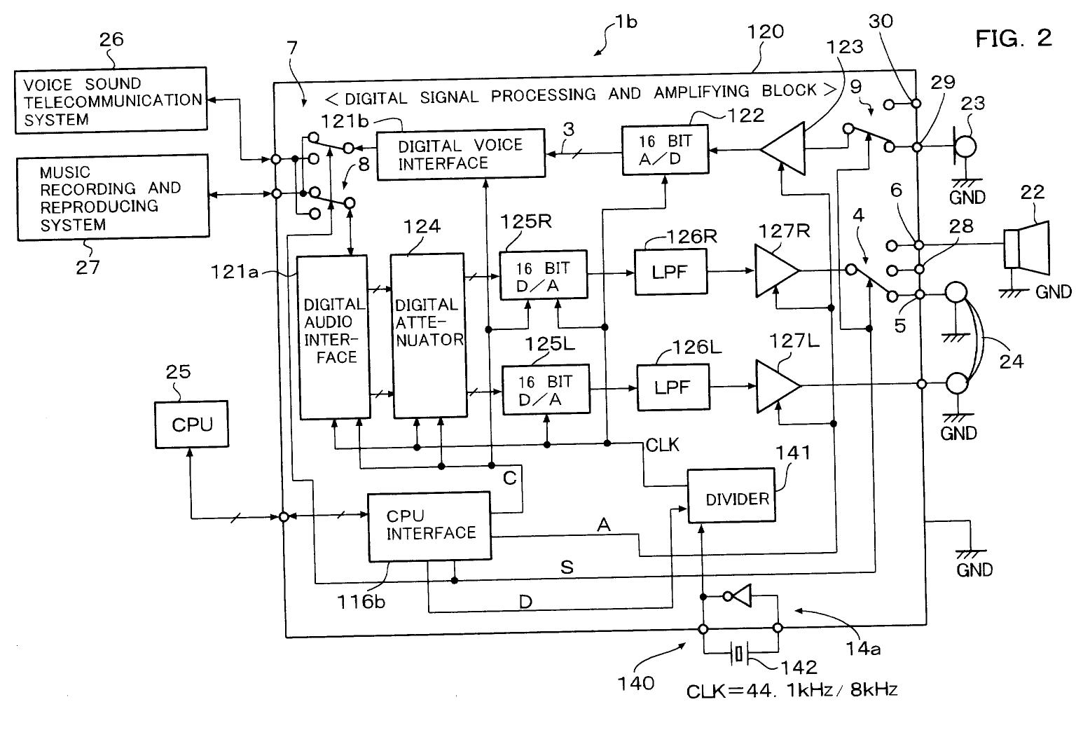

FIG. 2 is another embodiment of the present invention, and in FIG. 2 embodiment the digital voice interface 111 as shown in FIGS. 1 and 3 are not provided. In place of the digital voice interface 111, in FIG. 2 embodiment, among a 16 bit voice interface circuit in the digital audio interface 121 as shown in FIG. 1 an output side interface portion (a digital processing circuit for generating output signals) is taken out as a digital voice interface 121b in a form of a separate circuit and the circuit is provided at the position where the digital voice interface 111 was provided.

A circuit of the remaining interface portion (a digital processing circuit for receiving input signals and performing digital processing) formed by taking out the digital voice interface 121b is used as a digital audio interface 121a, in that the digital audio interface 121 is divided into two interfaces.

The input side of the digital voice interface 121b is connected via the connection line 3 to the 16 bit A/D 122 and the output side thereof is connected via a change-over switch circuit 7 to the voice sound telecommunication system 26 and the music recording and reproducing system 27, and the digital audio interface 121a is connected via a change-over switch circuit 8 to the voice sound telecommunication system 26 and the music recording and reproducing system 27.

Further, the change-over switch circuits 7 and 8 normally connect the digital voice interface 121b and the digital audio interface 121a toward the music recording and reproducing system 27.

In a one chip audio amplifier circuit 1b as shown in FIG. 2, the controller 13 as shown in FIGS. 1 and 3 is eliminated, and in place of the controller 13, a CPU interface 116b is provided. Control signals such as C to be outputted from the CPU interface 116b are increased in comparison with the CPU interface 116a as shown in FIG. 1 and the generation of clocks CK of 8 kHz is eliminated. However, the CPU interface 116b is a circuit corresponding to the CPU interface 116a except for the above. Further, in FIG. 2 circuit the change-over circuits 7 and 8 and external terminal 29 and 30 are added.

Like in FIG. 1, in FIG. 2 circuit through provision of two channels of R and L for the 16 bit A/D 122 and the amplifier 123 so as to correspond to the right and left channels in the stereo system, the respective outputs thereof can be inputted into the digital audio interface 121b.

Further, an output terminal 6 of the speaker 22, an external output terminal 28 and an output terminal 5 of R channel of the head phone 24 are selectively connected to the output of the amplifier 127R via the change-over switch circuit 4. The change-over switch circuit 4 normally connects the output terminal 5 and the output of the amplifier 127R, and the connection of the change-over switch circuit 4 is changed-over toward the output terminal 6 or toward the external output terminal 28 in response to a control signal from the external CPU 25 via a CPU interface 116b.

Still further, the input side of the amplifier 123 is selectively connected via a change-over switch circuit 9 to a mike input terminal 29 or an external input terminal 30 and the mike 23 is connected to the mike input terminal 29. The change-over switch circuit 9 normally connects the mike input terminal 29 and the input of the amplifier 123, and performs connection change-over toward the external terminal 30 in response to a control signal from the CPU 25 via the CPU interface 116b.

The 16 bit D/As 125R, 125L and the 16 bit A/D 122 receive from the clock generator circuit 14a either clock CLK of 44.1 kHz or clocks CK of 8 kHz.

The clock generator circuit 14a is constituted by the crystal oscillator 140, the divider 141 and the crystal 142 and the crystal 142 is externally connected with respect to the IC chip. The clock generator circuit 14a generates either clocks CK of 8 kHz or clocks CLK of 44.1 kHz through dividing operation by the divider 141 and sends out the same to the digital audio interface 121a, the 16 bit D/As 125R, 125L and the 16 bit A/D 122.

When the CPU interface 116b receives a speech related operation control signal in response to a control signal from the CPU 25, the CPU interface 116b generates a control signal D as a signal corresponding to the control signal SP as in FIG. 1 to change the dividing rate of the divider 141 to 5.5 times and causes the divider 141 to generate clocks CK of 8 kHz. When the CPU interface 116b receives a music related operation control signal or receives no specific control signal, the CPU interface 116b stops the control signal D. Thereby, the clock generator circuit 14a generates clocks CLK of 44.1 kHz through a predetermined dividing rate of the divider 141.

When the CPU interface 116b receives a speech related operation control signal in response to a control signal from the CPU 25, the CPU interface 116b further generates a control signal S and changes over the change-over switch circuits 7 and 8 toward the voice sound telecommunication system 26 to connect the same with the digital voice interface 121b and the digital audio interface 121a. Further, at this instance the CPU interface 116b changes over the change-over switch circuit 4 toward the output terminal 6 with the control signal S. Still further, at this moment the CPU interface 116b generates a control signal C, performs a change-over control of the effective bit number of the digital audio interface 121b, the digital voice interface 121b, the digital attenuator 124 and the 16 bit D/A respectively from 16 bits to 8 bits and renders the output of the digital audio interface 121a for the side of the 16 bit D/A 125L zero.

Further, when the CPU interface 116b receives a change-over signal toward the external connection terminal, the CPU interface 116b sends out the control signals to the change-over switch circuits 4 and 9 and performs change-over to connect these switch circuits with the external output terminal 28 and the external input terminal 30 respectively. Still further, such as the amplification rate of the amplifiers 123, 127R and 127L is controlled by a control signal A from the CPU interface 116b.

Now, a general operation of FIG. 2 embodiment will be explained, the audio amplifier circuit 1b is normally constituted like the audio related digital signal processing and amplifying block 12 as shown in FIG. 3 in which the digital audio interface 121a and the digital voice interface 121b are connected to the music recording and reproducing system 27, receives clocks CLK of 44.1 kHz from the divider 141 and operates to perform recording and reproducing of music signals.

When the CPU interface 116b receives a speech related change-over control signal from the external CPU 25, the CPU interface 116b generates the control signal S and changes over the change-over switch circuit 4 from connection to the output terminal 5 for R channel toward the output terminal 6 and changes over the change-over switch circuits 7 and 8 toward the voice sound telecommunication system 26 to connect the same with the digital voice interface 121b and the digital audio interface 121a. Further, the CPU interface 116b generates the control signal C and changes over the effective bit number of the digital audio interface 121a, the digital voice interface 121b, the digital attenuator 124 and the 16 bit D/A 125R into 8 bits, then changes over clocks CLK of 44.1 kHz from the clock generator circuit 14a into clocks CL of 8 kHz, and sends out the same to the 16 bit D/A 125R, 125L and the 16 bit A/D 122. Thereby, the 16 bit D/As 125R, 125L and the 16 bit A/D 122 receive clocks CK of 8 kHz from the divider 141, perform the operation equivalent to the speech related digital signal processing and amplifying block 11, and exchange data with the voice sound telecommunication system 26 for digital processing provided outside the chip via the digital voice interface 121b.

As has been explained above, since FIG. 2 embodiment can be achieved only by adding substantially such as the CPU interface 116b, and the change-over switch circuits 4, 7 and 8 to the conventional digital signal processing and amplifying block 12, thereby, the entire circuits can be formed into one chip IC and both speech related and audio related functions can be realized in a single chip IC.

In the above embodiments as has been explained hitherto, although the 16 bit A/D 122 for music related signals is used as the A/D conversion circuit for the mike 23, however, it is not necessarily required to use a 16 bit A/D, if the frequency resolution of an A/D is high. A speech related 8 bit A/D can be used therefor. Alternatively, an A/D with a bit number between 8 bits and 16 bits can be used. Further, a lower frequency resolution can be used with respect to the conversion bit number for speech related signals than that for the music related signals.

In the above embodiments, the speech related clocks are generated by the CPU interface circuit, however, such clocks can be generated by an internal clock generation circuit.

Further, although the CPU interface 116a and the controller 13 are a independent circuit respectively, in the described embodiment of FIG. 1, the CPU interface 116a and the controller 13 may be realized by a control circuit having an interface circuit for the CPU 25 (processor and a controller.

Still further, in the above embodiments examples of stereo signal processing has been explained with regard to audio related signals, however, a monaural processing can of course be used.

Still further, in the above embodiments a headphone is exemplified as one of speakers, however, both can be speakers and the present invention is not limited to the embodiments in which one of the speakers is the headphone. Moreover, the application of the present invention is not limited to the TV phone, the portable phone and the codec device, and the present invention can, of course, be applied to a variety of audio amplifier circuit with a digital interface which reproduces speech related and music related signals.

1. An audio amplifier circuit with a digital audio interface which processes data having digital values of music related audio signals in a bit number with a higher frequency resolution with respect to digital values of speech related voice sound signals comprising:
an A/D conversion circuit which converts analog input signals into digital signals in a predetermined bit number with a predetermined conversion frequency corresponding to the music related audio signals;
a D/A conversion circuit which converts the digital signals of the audio signals into analog signals with the predetermined frequency;
an amplifier circuit which receives the analog signals from the D/A conversion circuit and amplifies the same;
a digital interface which receives the digital signals converted by the A/D conversion circuit, outputs the same to a first external circuit or a first external device and sends out digital signals inputted from the first external circuit or the first external device to the D/A conversion circuit; and
a control circuit which supplies clocks or performs a supply control of clocks, whrein said clock has a speech related frequency lower than the predetermined frequency to the A/D conversion circuit and the D/A conversion circuit and whrein a data exchange with the first external circuit or the first external device is performed via the digital interface by causing the A/D conversion circuit and the D/A conversion circuit to perform conversion operation of the music related audio signals as well as another data exchange with a second external circuit or a second external device is performed via the digital interface by supplying the clocks to the A/D conversion circuit and the D/A conversion circuit through operation of the control circuit and by causing the same to perform conversion operation of the speech related voice sound signals.

2. An audio amplifier circuit with a digital audio interface according to claim 1, wherein the digital interface includes a first digital interface which performs data exchange with either the first external circuit or the first external device and a second digital interface which performs data exchange with either the second external circuit or the second external device.

3. An audio amplifier circuit with a digital audio interface according to claim 2, wherein the A/D conversion circuit is one which converts the analog input signals into digital signals having a bit number showing the high frequency resolution, the first external circuit or the first external device is a music recording and reproducing system, the second external circuit or the second external device is a voice sound telecommunication system, the first digital interface is connected to the music recording and reproducing system and the second digital interface is connected to the voice sound telecommunication system.

4. An audio amplifier circuit with a digital audio interface according to claim 3, wherein the predetermined frequency is substantially 44.1 kHz, the frequency corresponding to the speech related signals is substantially 8 kHz, a clock generation circuit for the frequency of 44.1 kHz and a change-over circuit are further provided, the control circuit generates clocks of the frequency of 8 kHz upon receipt of a control signal from a certain external circuit, the analog signals are ones which are formed by amplifying signals from a microphone by an amplifier, an output terminal of the amplifier circuit is selectively connected either to a head phone or a speaker by the change-over circuit in response to control of the control circuit and the respective circuits are integrated into one chip IC.

5. An audio amplifier circuit with a digital interface according to claim 4, wherein the A/D conversion circuit is connected with the second digital interface via wiring lines of the bit number corresponding to the digital values of the voice sound signals and is connected with the first digital interface via wiring lines of the bit number for the high frequency resolution.

6. An audio amplifier circuit with a digital audio interface according to claim 5, wherein the certain external circuit is a processor, the control circuit is constituted by an interface circuit for the processor and a controller, the clocks of the frequency of 8 kHz are generated by the interface circuit and the controller performs the change-over control of the change-over circuit.

7. An audio amplifier circuit with a digital audio interface according to claim 2, wherein the A/D conversion circuit is one which converts the analog input signals into digital signals having a bit number showing the high frequency resolution, the first external circuit or the first external device is a music recording and reproducing system, the second external circuit or the second external device is a voice sound telecommunication system, the first digital interface and the second digital interface are selectively connected to the music recording and reproducing system and to the voice sound telecommunication system via a change-over circuit.

8. An audio amplifier circuit with a digital audio interface according to claim 1, further comprising,
a clock generation circuit which selectively generates clocks having a predetermined frequency corresponding to the music related signals and clocks having a lower frequency than the predetermined frequency corresponding to the speech related signals in response to a first control signal,
the A/D conversion circuit is one which receives the clocks from the clock generation circuit and converts the analog input signals into digital signals having a bit number for the high frequency resolution,
the D/A conversion circuit is one which receives the clocks from the clock generation circuit, converts the music related digital signals to analog signals and further converts the digital signals having the speech related bit number into the analog signals,
the control circuit which generates the first control signal and performs control of changing over the clocks of the clock generation circuit either to the predetermined frequency or to the frequency corresponding to speech related signals.

9. An audio amplifier circuit with a digital audio interface according to claim 8, wherein the predetermined frequency is substantially 44.1 kHz, the frequency corresponding to the speech related signals is substantially 8 kHz, the A/D conversion circuit receives the clocks and selectively converts the analog input signals either into the digital signals having the bit number for the high frequency resolution or into the digital signals having the speech related bit number in response to a second control signal.

10. An audio amplifier circuit with a digital audio interface according to claim 9, wherein the digital interface includes a first digital interface which performs data exchange with either the first external circuit or the first external device and a second digital interface which performs data exchange with either the second external circuit or the second external device, the control circuit generates the first and second control signals upon receipt of a control signal from a certain external circuit, the analog signals are ones which are formed by amplifying signals from a microphone by an amplifier, an output terminal of the amplifier circuit is selectively connected either to a head phone or a speaker by a first change-over circuit in response to control of the control circuit and the respective circuits are integrated into one chip IC.

11. An audio amplifier circuit with a digital audio interface according to claim 10, wherein the first digital interface is a digital processing circuit of the digital audio interface which receives input signals and performs digital processing thereon for processing the digital signals having the bit number for the high frequency resolution, the second digital interface is a digital processing circuit of the digital audio interface which generates output signals of the audio digital interface, the first and second digital interfaces are ones which respectively perform data exchange with the first and second external circuits or the first and second external devices via a second change-over circuit, the certain external circuit is a processor, the control circuit is an interface circuit for the processor, and the interface circuit performs the change-over of the first and second change-over circuits.

12. A codec device provided with an audio amplifier circuit with a digital interface which processes data having digital values of music related audio signals in a bit number with a higher frequency resolution with respect to digital values of speech related voice sound signals comprising:
an A/D conversion circuit which converts analog input signals into digital signals in a predetermined bit number with a predetermined conversion frequency corresponding to the music related audio signals;
a D/A conversion circuit which converts the digital signals of the audio signals into analog signals with the predetermined frequency;
an amplifier circuit which receives the analog signals from the D/A conversion circuit and amplifies the same;
a digital interface which receives the digital signals converted by the A/D conversion circuit, outputs the same to a music recording and reproducing system and sends out digital signals inputted from the music recording and reproducing system to the D/A conversion circuit; and
a control circuit which supplies clocks or performs a supply control of clocks, wherein said clock has a speech related frequency lower than the predetermined frequency to the A/D conversion circuit and the D/A conversion circuit and wherein a data exchange with the music recording and reproducing system is performed via the digital interface by causing the A/D conversion circuit and the D/A conversion circuit to perform conversion operation of the music related audio signals as well as another data exchange with a voice sound telecommunication system is performed via the digital interface by supplying the clocks to the A/D conversion circuit and the D/A conversion circuit through operation of the control circuit and by causing the same to perform conversion operation of the speech related voice sound signals.

13. A codec device according to claim 12, wherein the digital interface includes a first digital interface and a second digital interface, the A/D conversion circuit is one which converts the analog input signals into digital signals having a bit number showing the high frequency resolution, the first digital interface is connected to the music recording and reproducing system and the second digital interface is connected to the voice sound telecommunication system.

14. A codec device according to claim 13, wherein the predetermined frequency is substantially 44.1 kHz, the frequency corresponding to the speech related signals is substantially 8 kHz, a clock generation circuit and a change-over circuit for the frequency of 44.1 kHz are further provided, the control circuit generates clocks of the frequency of 8 kHz upon receipt of a control signal from a certain external circuit, the analog signals are ones hich are formed by amplifying signals from a microphone by an amplifier, an output terminal of the amplifier circuit is selectively connected either to a head phone or a speaker by the change-over circuit in response to control of the control circuit and the respective circuits are integrated into one chip IC.

15. A codec device according to claim 14, wherein the certain external circuit is a processor, the control circuit is constituted by an interface circuit for the processor and a controller, the clocks of the frequency of 8 kHz are generated by the interface circuit and the controller performs the change-over control of the change-over circuit.

16. A codec device according to claim 12, further comprising,
a clock generation circuit which selectively generates clocks having a predetermined frequency corresponding to the music related signals and clocks having a lower frequency than the predetermined frequency corresponding to the speech related signals in response to a first control signal,
the A/D conversion circuit is one which receives the clocks from the clock generation circuit and converts the analog input signals into digital signals having a predetermined bit number,
the D/A conversion circuit is one which receives the clocks from the clock generation circuit, converts the music related digital signals to analog signals and further converts the digital signals having the speech related bit number into the analog signals,
the control circuit which generates the first control signal and performs control of changing over the clocks of the clock generation circuit either to the predetermined frequency or to the frequency corresponding to speech related signals.

17. A codec device according to claim 16, wherein the predetermined frequency is substantially 44.1 kHz, the frequency corresponding to the speech related signals is substantially 8 kHz, the A/D conversion circuit receives the clocks and selectively converts the analog input signals either into the digital signals having the bit number for the high frequency resolution or into the digital signals having the speech related bit number.
